(19) United States
(12) Patent Application Publication
(10) Pub. No.: US 2025/0105777 A1
(43) Pub. Date: Mar. 27, 2025

(54) PHOTOVOLTAIC POWER SUPPLY DEVICE

(71) Applicant: TOYODA GOSEI CO., LTD., Kiyosu-shi (JP)

(72) Inventors: Seigi SHIMIZU, Kiyosu-shi (JP); Shigeo TAKEDA, Kiyosu-shi (JP); Yu SHIMOMURA, Kiyosu-shi (JP); Yuki TOKUYAMA, Kiyosu-shi (JP); Takuya SENGA, Kiyosu-shi (JP); Shinichiro FUKI, Kiyosu-shi (JP)

(21) Appl. No.: 18/824,630

(22) Filed: Sep. 4, 2024

(30) Foreign Application Priority Data
Sep. 26, 2023 (JP) 2023-163679

(51) Int. Cl. H02S 20/30; H02S 10/40; H02S 40/38

(52) U.S. Cl. CPC H02S 20/30; H02S 10/40; H02S 40/38

(57) ABSTRACT

A photovoltaic power supply device includes a base and a solar cell panel. The base is removably attached to a mobile terminal and includes a base surface (front surface). The solar cell panel is electrically connected to the base and includes a light receiving surface on an outer surface on one side in a thickness direction. Power generated by the solar cell panel is supplied to the mobile terminal via the base. The solar cell panel is supported by the base with a shaft. The position of the solar cell panel with respect to the base is variable. The position includes a retracted position in which the entirety of the solar cell panel overlaps with the base surface from the outside of the base, and a use position in which the solar cell panel does not overlap with the base surface outside the base and is tiltable about the shaft.

### CROSS-REFERENCE TO RELATED APPLICATIONS

This application is based upon and claims the benefit of priority from prior Japanese Patent Application No. 2023-163679, filed on Sep. 26, 2023, the entire contents of which are incorporated herein by reference.

### BACKGROUND

### 1. Field

The present disclosure relates to a photovoltaic power supply device that includes a solar cell panel and supplies power generated by the solar cell panel to an electronic device such as a mobile terminal.

### 2. Description of Related Art

For example, as disclosed in Japanese Laid-Open Patent Publication No. 2016-42778, solar cells have been used to supply power to electronic devices such as smartphones in recent years. Additionally, as disclosed in Japanese Laid-Open Patent Publication No. 2015-142421, compact power supply devices that provide power to electronic devices without using a commercial power source have been proposed.

In this respect, as shown in FIG. 19, it is conceivable to attach a small photovoltaic power supply device A, which is formed by fixing a solar cell panel 202 to a base 204, to an electronic device 201. Power generated by the solar cell panel 202 is supplied to the electronic device 201 through the base 204.

However, as shown in FIG. 20, when the user holds the photovoltaic power supply device A together with the electronic device 201 during use, a large portion of a light receiving surface 203 of the solar cell panel 202 is covered by the user's hand HA. In this case, the hand HA, which is between a light source LS such as the sun and the light receiving surface 203, significantly blocks the light from the light source LS. The power generation efficiency of the solar cell panel 202 is reduced by an amount corresponding to the blocked light irradiation to the light receiving surface 203.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a photovoltaic power supply device includes a base removably attached to an electronic device and including a base surface on an outer surface on one side in a thickness direction of the base, and a solar cell panel electrically connected to the base and including a light receiving surface on an outer surface on at least one side in a thickness direction of the solar cell panel. The photovoltaic power supply device is configured such that power generated by the solar cell panel is supplied to the electronic device via the base. The solar cell panel is supported by the base with a shaft. A position of the solar cell panel with respect to the base is variable. The position includes a retracted position in which the entirety of the solar cell panel overlaps with the base surface from the outside of the base or is accommodated inside the base, and a use position in which the solar cell panel does not overlap with the base surface outside the base and is tiltable about the shaft.

Other features and aspects will be apparent from the following detailed description, the drawings, and the claims.

### BRIEF DESCRIPTION OF THE DRAWINGS

FIG. 1 is a perspective view showing an example of a usage mode of a photovoltaic power supply device according to a first embodiment.

FIG. 2 is a side view showing a state in which the photovoltaic power supply device according to the first embodiment is mounted on a mobile terminal.

FIG. 3 is a front view showing a state in which the photovoltaic power supply device according to the first embodiment is attached to the mobile terminal, as viewed from a side on which the photovoltaic power supply device is provided.

FIG. 4 is an enlarged partial front view of section X of FIG. 3.

FIG. 5 is a schematic diagram showing a solar cell panel according to the first embodiment.

FIG. 6 is a cross-sectional view taken along line 6-6 in FIG. 7.

FIG. 7 is a front view showing a base attached to the mobile terminal and a solar cell panel in a separated manner in the first embodiment.

FIG. 8 is an exploded partial perspective view illustrating a support structure in a state in which a shaft is removed from a shaft receiving hole in the first embodiment.

FIG. 9 is an exploded partial perspective view illustrating a relay structure in a state in which a terminal portion is removed from a connection hole in the first embodiment.

FIG. 10 is a block diagram showing an electrical configuration of the photovoltaic power supply device according to the first embodiment together with the mobile terminal.

FIG. 11 is a side view showing another usage mode of the photovoltaic power supply device according to the first embodiment.

FIG. 12 is a side view showing an example of a usage mode of a photovoltaic power supply device according to a second embodiment.

FIG. 13 is a side view showing another usage mode of the photovoltaic power supply device according to the second embodiment.

FIG. 14 is a partial front view diagram corresponding to FIG. 4, illustrating a modification of the first embodiment, in which a shaft (a rotary shaft and an external gear) is inserted into a shaft receiving hole.

FIG. 15 is an exploded partial perspective view corresponding to FIG. 8, illustrating a modification of the first embodiment, in which a shaft (a rotary shaft and an external gear) is removed from a shaft receiving hole.

FIG. 16 is a perspective view corresponding to FIG. 1, illustrating a usage mode of a photovoltaic power supply device according to a modification of the first embodiment.

FIG. 17 is a side view corresponding to FIG. 12, illustrating a usage mode of a photovoltaic power supply device according to a modification of the second embodiment.

FIG. 18 is a schematic diagram corresponding to FIG. 5, illustrating a solar cell panel according to a modification of the second embodiment.

FIG. 19 is a side view showing a state in which a photovoltaic power supply device of a related art is attached to an electronic device.

FIG. 20 is a perspective view showing a usage mode of the photovoltaic power supply device of the related art.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

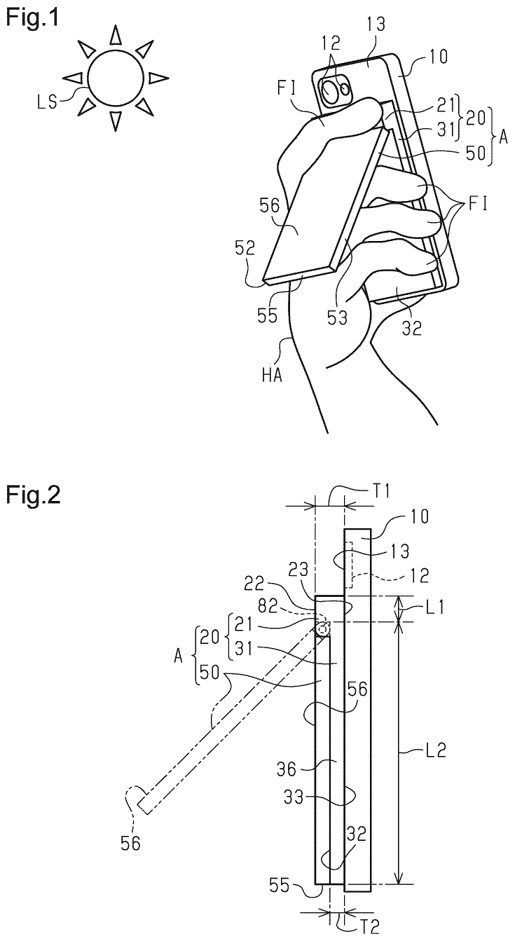

A photovoltaic power supply device A according to a first embodiment will now be described with reference to FIGS. 1 to 11.

The photovoltaic power supply device A is a device that is attached to an electronic device and supplies power generated by a solar cell panel to the electronic device.

### Mobile Terminal 10

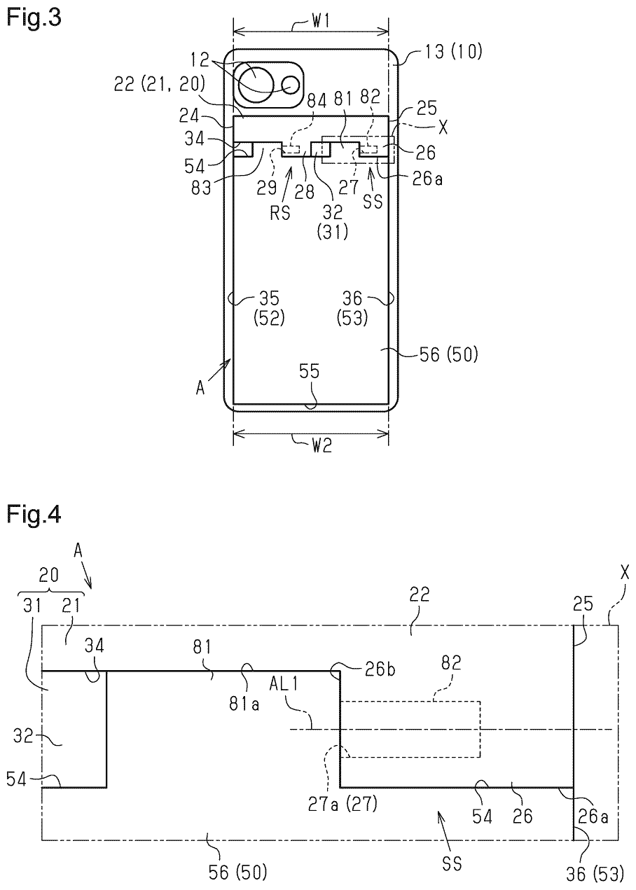

As shown in FIGS. 2 and 3, in the first embodiment, a mobile terminal 10, which is a portable communication device such as a smartphone or a mobile phone, is an electronic device. A smartphone is a portable telephone terminal having many functions in addition to a call function as a mobile phone. A smartphone has, for example, an image capturing function provided by a camera and a web information display function like a personal computer.

The mobile terminal 10 has a rectangular plate-shaped outline. Although not illustrated, the mobile terminal 10 includes a CPU, a memory, a display, an input device, a communication device, and the like. As shown in FIG. 10, the mobile terminal 10 includes a built-in power storage unit 11 composed of a rechargeable battery, and is configured to perform its own functions using the power storage unit 11 as a power source.

As shown in FIGS. 1 and 3, the mobile terminal 10 incorporates camera at one end in the length direction. A lens 12 of the camera is exposed on a back surface 13 of the mobile terminal 10.

The photovoltaic power supply device A includes a base 20 and a solar cell panel 50.

### Base 20

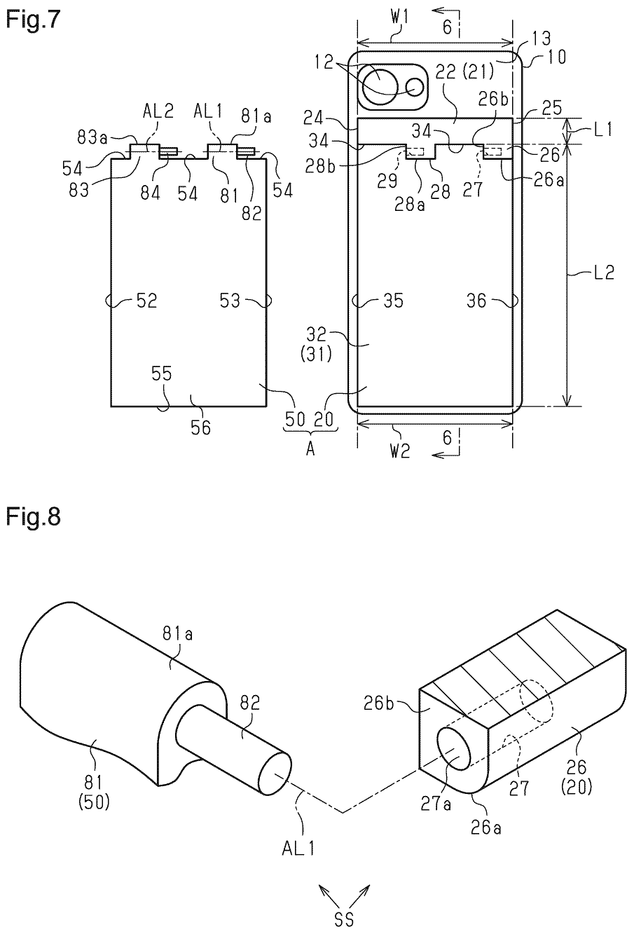

As shown in FIGS. 2 and 7, the base 20 includes a first functional portion 21 and a second functional portion 31. In order to define each portion of the base 20, two directions orthogonal to each other are referred to as a width direction and a length direction, and a direction orthogonal to both directions is referred to as a thickness direction.

The first functional portion 21 and the second functional portion 31 are adjacent to each other in the length direction. A dimension W1 of the first functional portion 21 in the width direction is set to be the same as a dimension W2 of the second functional portion 31 in the same direction. A dimension L2 of the second functional portion 31 in the length direction is set to be greater than the dimension L1 of the first functional portion 21 in the same direction.

As shown in FIGS. 2 and 6, the first functional portion 21 has a rectangular cross section. As shown in FIG. 7, the second functional portion 31 has the shape of a rectangular plate in which the dimension L2 in the length direction is greater than the dimension W2 in the width direction.

As shown in FIGS. 2 and 6, an outer surface of the first functional portion 21, which is on one side in the thickness direction of the base 20, is referred to as a front surface 22, and the surface on the other side is referred to as a back surface 23. Further, as shown in FIGS. 3 and 7, the surfaces on the opposite sides of the first functional portion 21 in the width direction of the base 20 are referred to as side surfaces 24, 25.

As shown in FIGS. 2 and 6, an outer surface of the second functional portion 31, which is on one side in the thickness direction, is referred to as a front surface 32, and the surface on the other side is referred to as a back surface 33. The back surface 23 of the first functional portion 21 and the back surface 33 of the second functional portion 31 are located on the same plane. Further, as shown in FIGS. 3 and 7, the surfaces on the opposite sides of the second functional portion 31 in the width direction of the base 20 are referred to as side surfaces 35, 36.

As shown in FIG. 2, a dimension T1 of the first functional portion 21 in the thickness direction is set to be greater than a dimension T2 of the second functional portion 31 in the same direction. The front surface 22 of the first functional portion 21 is disposed at a position more distant from the back surfaces 23, 33 in the thickness direction than the front surface 32 of the second functional portion 31 is. As shown in FIGS. 6 and 7, a stepped surface 34 extending in the thickness direction and the width direction is formed between the front surface 22 of the first functional portion 21 and the front surface 32 of the second functional portion 31. The front surface 32 of the second functional portion 31 forms a base surface of the base 20.

As shown in FIGS. 2 and 6, the base 20 is detachably attached to the mobile terminal 10 with both of the back surfaces 23, 33 placed against the back surface 13 of the mobile terminal 10. For example, the base 20 is attached to a predetermined position on the mobile terminal 10 by using an attraction force of a magnet disposed in at least one of the interior of the second functional portion 31 in the base 20 and the interior of the mobile terminal 10. The lens 12 is preferably exposed so that the camera can capture images even when the base 20 is attached to the mobile terminal 10.

In a state in which the base 20 is attached to the mobile terminal 10, the front surface 22 of the first functional portion 21 is disposed at a position more distant from the back surface 13 of the mobile terminal 10 in the thickness direction than the front surface 32 (base surface) of the second functional portion 31 is.

Further, the base 20 is formed to have a shape and a size that can be held together with the mobile terminal 10. The size includes a thickness.

As shown in FIG. 10, the base 20 includes a power receiving unit 41, a power storage unit 42, a power transmitting unit 43, and a controlling unit 44. The power receiving unit 41 is electrically connected to the solar cell panel 50 to receive power supplied from the solar cell panel 50. An electrical connection structure (relay structure RS) between the power receiving unit 41 and the solar cell panel 50 will be discussed below.

The power storage unit 42 includes a rechargeable battery that can be repeatedly charged and discharged, such as a nickel-metal hydride battery or a lithium-ion rechargeable battery. The power transmitting unit 43 transmits (supplies) some of the power stored in the power storage unit 42 to the mobile terminal 10. In the controlling unit 44, for example, a hardware processor such as a CPU executes programs (software). The controlling unit 44 controls the transmission (supply) of power from the power transmitting unit 43 to the mobile terminal 10. Based on the charging state of the power storage unit 42, the controlling unit 44 controls the storage of power received through the power receiving unit 41 in the power storage unit 42.

The power receiving unit 41, the power storage unit 42, a part of the power transmitting unit 43, and the controlling unit 44 are disposed, for example, inside the first functional portion 21 of the base 20.

Power is supplied from the power transmitting unit 43 to the mobile terminal 10 by a contactless (wireless) power transmission method capable of transmitting power without using a metal contact, a connector, or the like. This method is also called contactless power supply, contactless power transmission, or the like. In the first embodiment, contactless power transmission with an electromagnetic induction method is employed among non-radiation methods that can be used in a relatively close region. The power transmitting unit 43 includes, as a primary coil, a power transmitter coil (not shown), which generates a magnetic field (magnetic flux) when energized. The power transmitter coil is disposed inside the second functional portion 31 of the base 20.

The mobile terminal 10 includes a power receiver coil (not shown) as a secondary coil. As shown in FIGS. 2 and 6, when the back surfaces 23, 33 of the base 20 are placed against and attracted to the back surface 13 of the mobile terminal 10, the power transmitter coil and the power receiver coil are electromagnetically coupled together to convert a magnetic field into electric power. The converted power is stored in a power storage unit 11 (see FIG. 10) of the mobile terminal 10.

Instead of the above-described electromagnetic induction method, a magnetic field resonance method, an electric field coupling method, a radio wave field coupling method, a radio wave receiving method, or the like may be used as a contactless power transmission method.

### Solar Cell Panel 50

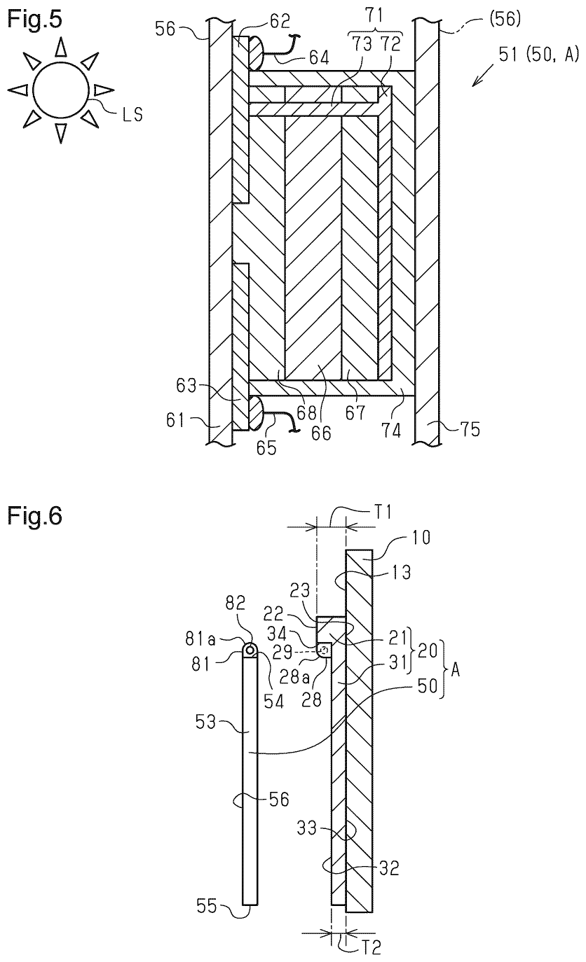

As shown in FIG. 1, the solar cell panel 50 has the shape of a thin plate extending in a planar manner. In the first embodiment, a thin-film solar cell 51 (see FIG. 5) such as a perovskite solar cell is employed as the solar cell panel 50. The solar cell panel 50 has the shape of a rectangular plate. In order to define each portion of the solar cell panel 50, two directions orthogonal to each other are referred to as a width direction and a length direction, and a direction orthogonal to both directions is referred to as a thickness direction. As shown in FIGS. 6 and 7, the solar cell panel 50 includes two side surfaces 52, 53 and two end faces 54, 55. The side surfaces 52, 53 are on the opposite sides in the width direction and extend in the length direction while being parallel with each other. The end faces 54, 55 are on the opposite sides in the length direction and extend in the width direction while being parallel with each other. The solar cell panel 50 includes a light receiving surface 56, which is one of the surfaces on the opposite sides in the thickness direction. In the first embodiment, the light receiving surface 56 is a surface on the opposite side to the front surface 32 of the second functional portion 31.

FIG. 5 shows a schematic configuration of the thin-film solar cell 51.

Portions on the opposite sides in the thickness direction (lateral direction in FIG. 5) of the thin-film solar cell 51 are formed by two base members 61, 75, respectively. The base members 61, 75 are made of a transparent or translucent material that is transmissive to light, for example, a plastic film, glass, or the like.

The thin-film solar cell 51 includes a power generation layer 66, a hole transport layer 67, an electron transport layer 68, positive electrodes 62, 71, negative electrode 63, and a sealing material 74 between the base members 61, 75.

The power generation layer 66 is a layer that absorbs light generated by the light source LS and performs photoelectric conversion. The light source LS is typically the sun, but may be a light device or the like.

The power generation layer 66 is made of a metal halide material having a perovskite structure (hereinafter, referred to as a “perovskite compound”). The perovskite compound has an octahedral crystal structure represented by the formula AMX3, where A is a monovalent cation, M is a divalent metal cation, and X is a halide ion.

The hole transport layer 67 and the electron transport layer 68 are disposed on the opposite sides of the power generation layer 66 in the thickness direction. The hole transport layer 67 is disposed on the power generation layer 66 and located between the power generation layer 66 and the base member 75. The electron transport layer 68 is disposed on the power generation layer 66 and located between the power generation layer 66 and the base member 61.

The positive electrodes 62, 71 are electrically connected to the hole transport layer 67. The positive electrode 62 is disposed on the base member 61 and is located between the base member 61 and the base member 75. In other words, the positive electrode 62 is stacked on the inner surface of the base member 61 in the thickness direction. A part of the positive electrode 62 is located between the base member 61 and the electron transport layer 68.

The positive electrode 71 includes an electrode body 72 and an electrode connector portion 73. The entire positive electrode 71 is made of a conductive metal. The electrode body 72 is stacked on a surface of the hole transport layer 67 on the side opposite to the power generation layer 66 (side closer to the base member 75). The electrode connector portion 73 extends in the thickness direction of the thin-film solar cell 51 and passes through the hole transport layer 67, the power generation layer 66, and the electron transport layer 68. One end of the electrode connector portion 73 is connected to the electrode body 72, and the other end is connected to the positive electrode 62. A wiring member 64 is connected to the positive electrode 62.

The negative electrode 63 is connected to the electron transport layer 68. The negative electrode 63 is stacked on an inner surface of the base member 61 in the thickness direction at a position separated from the positive electrode 62. A part of the negative electrode 63 is located between the base member 61 and the electron transport layer 68. A wiring member 65 is connected to the negative electrode 63.

The positive electrode 62 and the negative electrode 63 are both made of a transparent or translucent material that is transmissive to light and has electrical conductivity. For example, the positive electrode 62 and the negative electrode 63 are made of a metal oxide film such as indium tin oxide (ITO) or zinc oxide (ZnO).

The sealing material 74 is located between the base member 75 and the set of the positive electrode 62 and the negative electrode 63, and covers the power generation layer 66, the hole transport layer 67, the electron transport layer 68, and the electrode body 72.

In the thin-film solar cell 51 having the above-described configuration, the surface of the base member 61 on the side opposite to the base member 75, that is, a surface of the base member 61 on one side in the thickness direction of the thin-film solar cell 51, forms the light receiving surface 56.

### Support Structure SS

As shown in FIGS. 3, 4, 7, and 8, the solar cell panel 50 is mechanically supported by the base 20 with the following support structure SS.

In a state in which the solar cell panel 50 is supported by the base 20, a protrusion 81 protrudes from a part of the outer periphery of the solar cell panel 50. The protrusion 81 protrudes toward the first functional portion 21 from a portion near the side surface 53 on the end face 54 close to the first functional portion 21. A distal end face of the protrusion 81 in the protruding direction is formed by a curved surface 81a that bulges toward the first functional portion 21. The curved surface 81a is provided to prevent the protrusion 81 and the stepped surface 34 of the first functional portion 21 from contacting each other when the solar cell panel 50 is tilted. A shaft 82 extending along a first axis AL1 parallel with the width direction is fixed to the protrusion 81. The shaft 82 protrudes from the protrusion 81 toward the side surface 53.

A shaft receiving portion 26 protrudes from the stepped surface 34 of the first functional portion 21. The shaft receiving portion 26 protrudes from a position adjacent to the side surface 25 on one side of the first functional portion 21 toward the end face 54 of the solar cell panel 50. The shaft receiving portion 26 includes a curved surface 26a formed by rounding at a boundary between a surface opposite to the first functional portion 21 and a surface opposite to the front surface 32 of the second functional portion 31. The curved surface 26a is provided to prevent the shaft receiving portion 26 and the end face 54 of the solar cell panel 50 from contacting each other when the solar cell panel 50 is tilted.

The shaft receiving portion 26 includes a shaft receiving hole 27 at a position on the same line as the first axis AL1. The shaft receiving hole 27 opens in an end face 26b of the shaft receiving portion 26. The end face 26b is closer to the side surface 24 (the protrusion 81). The shaft receiving hole 27 extends toward the side surface 25 along the first axis AL1. The shaft 82 is removably inserted into the shaft receiving hole 27 by a relative movement of the base 20 and the solar cell panel 50.

### Relay Structure RS

As shown in FIGS. 3, 7, and 9, the solar cell panel 50 is connected to the base 20 by a relay structure RS discussed below such that the solar cell panel 50 and the base 20 can be electrically disconnected. This disconnectable connection is established by relative movement of the base 20 and the solar cell panel 50.

The base 20 is provided with a connectable portion, and the solar cell panel 50 is provided with a connection portion. The connectable portion and the connection portion are formed by a combination of a connection hole 29 and a terminal portion 84 that extend along a second axis AL2 that is positioned on the same line as the first axis AL1.

In the first embodiment, the connection hole 29 is provided as a connectable portion, and the terminal portion 84 is provided as a connection portion. Specifically, a protrusion 28 protrudes from the stepped surface 34 of the first functional portion 21. The protrusion 28 protrudes toward the solar cell panel 50 from a portion of the stepped surface 34 between the shaft receiving portion 26 and the side surface 24. The protrusion 28 includes a curved surface 28a formed by rounding the boundary between the surface opposite to the first functional portion 21 and the surface opposite to the front surface 32 of the second functional portion 31. The curved surface 28a is provided to prevent the protrusion 28 and the end face 54 of the solar cell panel 50 from contacting each other when the solar cell panel 50 is tilted.

The connection hole 29 opens in an end face 28b of the protrusion 28 that is closer to the side surface 24. The connection hole 29 extends along the second axis AL2 toward the side surface 25. An inner wall surface 29a of the connection hole 29 includes a positive-terminal receiving portion and a negative-terminal receiving portion (neither is shown), which are insulated from each other. The positive-terminal receiving portion and the negative-terminal receiving portion are connected to the power receiving unit 41 (see FIG. 10) in the base 20.

A protrusion 83 protrudes from the end face 54 of the solar cell panel 50. The protrusion 83 protrudes from a portion of the end face 54 close to the side surface 52 toward the stepped surface 34 of the first functional portion 21. A distal end face of the protrusion 83 in the protruding direction includes a curved surface 83a that bulges toward the first functional portion 21. The curved surface 83a is provided to prevent the protrusion 83 and the stepped surface 34 of the first functional portion 21 from contacting each other when the solar cell panel 50 is tilted.

The terminal portion 84 is fixed to the protrusion 83. The terminal portion 84 protrudes along the second axis AL2 from the protrusion 83 toward the side surface 53.

The terminal portion 84 includes a positive terminal portion and a negative terminal portion (neither is shown), which are insulated from each other. The positive electrode 62 is electrically connected to the positive terminal portion via the wiring member 64. The negative electrode 63 is electrically connected to the negative terminal portion via the wiring member 65.

The terminal portion 84 is removably inserted into the connection hole 29 as the shaft 82 is inserted into the shaft receiving hole 27. The terminal portion 84 inserted into the connection hole 29 is supported by the inner wall surface 29a so as to rotate about the second axis AL2 while being in contact with the inner wall surface 29a.

The state in which the terminal portion 84 is in contact with the inner wall surface 29a is a state in which the terminal portion 84 and the connection hole 29 are electrically connected to each other. Specifically, the positive terminal portion is in contact with and electrically connected to the positive-terminal receiving portion, and the negative terminal portion is in contact with and electrically connected to the negative-terminal receiving portion.

As the shaft 82 is removed from the shaft receiving hole 27, the terminal portion 84 is removed from the connection hole 29, so that the electrical connection of the terminal portion 84 to the connection hole 29 is discontinued.

### Position of Solar Cell Panel 50

The solar cell panel 50 can change its position with respect to the base 20. The position includes a retracted position and a use position.

As indicated by solid lines in FIG. 2, the retracted position is a position in which the entire solar cell panel 50 overlaps with the front surface 32 (base surface) of the second functional portion 31 from the outside of the base 20. In the retracted position, the solar cell panel 50 is parallel with the front surface 32 and is not tilted with respect to the front surface 32.

As indicated by long-dash double-short-dash lines in FIG. 2, the use position is a position in which the entire solar cell panel 50 does not overlap with the front surface 32 (base surface) outside the base 20 and can tilt about the shaft 82. In the use position, the solar cell panel 50 is tilted with respect to the front surface 32.

As shown in FIG. 8, the shaft 82 is press-fitted into the shaft receiving hole 27. Friction is generated between the outer circumferential surface of the shaft 82 and the inner wall surface 27a of the shaft receiving hole 27. This friction is set to a magnitude that enables angle adjustment of the solar cell panel 50 in the use position with respect to the base 20.

The angle adjustment refers to changing the tilt angle of the solar cell panel 50 with respect to the base 20 within a specified angle range and maintaining the solar cell panel 50 at the changed tilt angle. The tilt angle is changed by tilting the solar cell panel 50 about the shaft 82.

In addition, when the solar cell panel 50 is tilted by the hand HA, a load of an appropriate magnitude is generated as an operation load due to friction.

When an external force large enough to overcome the friction is applied to the solar cell panel 50 in the thickness direction, the solar cell panel 50 is tilted about the shaft 82. In contrast, when an external force is applied to the solar cell panel 50 but the external force is smaller than the magnitude that overcomes the friction, or when no external force is applied, the solar cell panel 50 is maintained at the tilt angle at that time.

Operation of the first embodiment, which is configured as described above, will now be described.

### Power Supply to Mobile Terminal 10

As shown in FIG. 2, the photovoltaic power supply device A is attached to the back surface 13 of the mobile terminal 10, which is compatible with contactless power supply, in the base 20. Specifically, the base 20 is attracted to the mobile terminal 10 by the magnetic force of the magnet while the back surfaces 23, 33 of the base 20 are placed against the back surface 13 with the positions of the back surfaces 23, 33 determined. As the base 20 is attached to the mobile terminal 10, the power transmitter coil of the solar cell panel 50 and the power receiver coil of the mobile terminal 10 are electromagnetically coupled to each other, so that the photovoltaic power supply device A is electrically connected to the mobile terminal 10.

As shown in FIG. 10, the power stored in the power storage unit 42 of the base 20 is transmitted to the mobile terminal 10 by contactless power supply by the controlling unit 44 controlling the power transmitting unit 43, and is stored in the power storage unit 11. Power can be supplied from the photovoltaic power supply device A to the mobile terminal 10 regardless of the position of the solar cell panel 50.

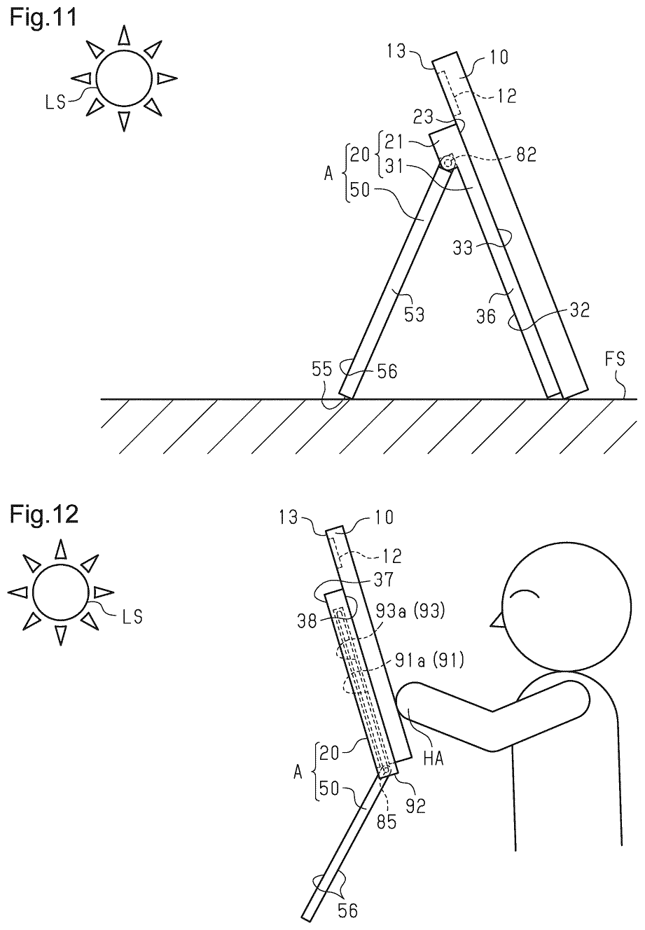

As shown in FIG. 11, the mobile terminal 10 operates using the power stored in the power storage unit 11, enabling its calling and communication functions. The mobile terminal 10 can operate with or without the photovoltaic power supply device A attached to the mobile terminal 10. Furthermore, when the solar power supply device A is attached, the mobile terminal 10 can function regardless of the position of the solar cell panel 50.

### Power Generation and Power Storage by Photovoltaic Power Supply Device A

As shown in FIG. 5, the thin-film solar cell 51 of the solar cell panel 50 includes the base member 61, which includes the light receiving surface 56, and the base member 61 and the member located between the base member 61 and the power generation layer 66 are transmissive to light. Therefore, in the photovoltaic power supply device A, when the light receiving surface 56 of the solar cell panel 50 is directed to the light source LS, the light receiving surface 56 is irradiated with the light of the light source LS. The solar cell panel 50 generates power having a magnitude corresponding to the amount of light with which the light receiving surface 56 is irradiated. Specifically, some of the light applied to the light receiving surface 56 is transmitted through the base member 61, the positive electrode 62, and the electron transport layer 68, and reaches the power generation layer 66. The remaining light passes through the base member 61, the negative electrode 63, and the electron transport layer 68, and reaches the power generation layer 66. Further, the remaining light passes through the base member 61 and the electron transport layer 68, and reaches the power generation layer 66.

In the power generation layer 66, holes and electrons are generated by photoexcitation. The holes are transported to the positive electrodes 71, 62 by the hole transport layer 67. The electrons are transported to the negative electrode 63 by the electron transport layer 68. Then, a current is extracted from the wiring member 64, connected to the positive electrode 62, and the wiring member 65, connected to the negative electrode 63.

Power generation is possible by directing the light receiving surface 56 of the solar cell panel 50 in the retracted position shown in FIGS. 2 and 3 toward the light source LS. Power generation is also possible by directing the light receiving surface 56 of the solar cell panel 50 in the use position toward the light source LS. At this time, as shown in FIG. 1, the light receiving surface 56 may be directed toward the light source LS by tilting the solar cell panel 50 in a state in which the base 20 is held together with the mobile terminal 10.

Further, as shown in FIG. 11, the photovoltaic power supply device A in a state in which the solar cell panel 50 is tilted with respect to the base 20 may be placed on a flat surface FS such as a desk without being held by the hand HA. In this case, both the base 20 and the solar cell panel 50 are placed in a state of being tilted with respect to the flat surface FS. Power can be generated by the solar cell panel 50 while the mobile terminal 10 is maintained in a tilted state by the photovoltaic power supply device A. At this time, the mobile terminal 10 in the tilted state may be used for a call, communication, or the like.

Although not illustrated, power generation is also possible when the photovoltaic power supply device A is used alone without being attached to the mobile terminal 10.

As shown in FIGS. 5, 9, and 10, the power generated by the solar cell panel 50 is supplied to the power receiving unit 41 via the wiring members 64, 65, the terminal portion 84, and the connection hole 29. The power is then stored in the power storage unit 42 by the controlling unit 44 controlling the power receiving unit 41.

### Reduction of Decrease in Power Generation Efficiency of Solar Cell Panel 50

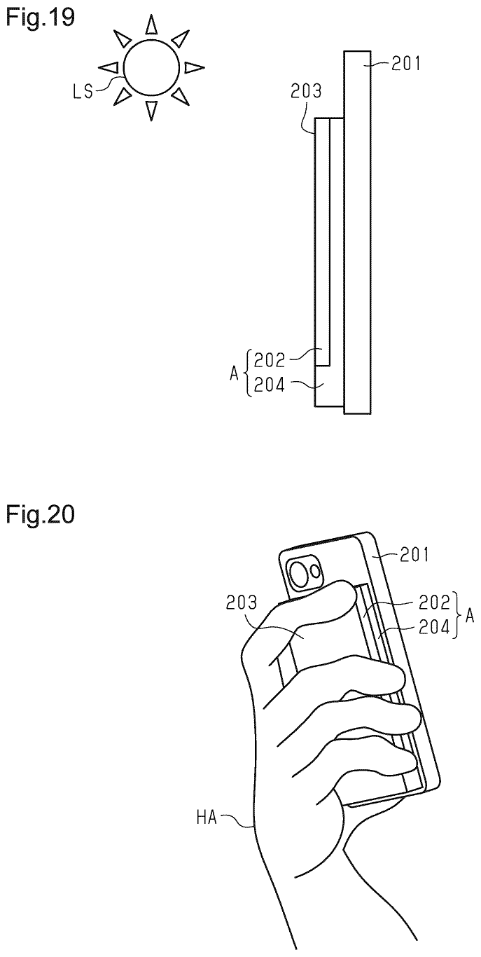

In the use of the mobile terminal 10 to which the photovoltaic power supply device A is attached, the mobile terminal 10 may be held by the hand HA with the solar cell panel 50 in the retracted position. In this case, the light receiving surface 56 may be covered by the hand HA. This is because, in the retracted position, the solar cell panel 50 overlaps with the front surface 32 (base surface) from the outside of the base 20 as indicated by the solid lines in FIG. 2, so that the photovoltaic power supply device A has a compact shape and size suitable for gripping. Specifically, when the solar cell panel 50 is in the retracted position, the photovoltaic power supply device A is in the same state as the photovoltaic power supply device A in the related art, in which a solar cell panel 202 is fixed to a base 204, as shown in FIGS. 19 and 20. In this case, the hand HA is located between the light source LS and the light receiving surface 56, and irradiation of light to the light receiving surface 56 is largely blocked by the hand HA. Since the light is blocked by the hand HA, the amount of light with which the light receiving surface 56 is irradiated decreases, and the power generation efficiency of the solar cell panel 50 decreases.

In this regard, as shown in FIG. 2, the solar cell panel 50 is tiltable about the shaft 82. In addition, as shown in FIG. 8, a friction large enough to enable the angle adjustment of the solar cell panel 50 with respect to the base 20 is generated between the shaft 82 and the inner wall surface 27a of the shaft receiving hole 27.

As shown in FIG. 3, the terminal portion 84, which is on the same line as the shaft 82, supports the solar cell panel 50 in an auxiliary manner so that the solar cell panel 50 is tiltable with respect to the base 20.

The solar cell panel 50 in the retracted position receives an external force in the thickness direction by the hand HA. When an external force large enough to overcome the friction is applied to the solar cell panel 50, the solar cell panel 50 is tilted about the shaft 82. As a result of this tilting, the solar cell panel 50 is brought into the use position, in which the solar cell panel 50 does not overlap with the front surface 32 (base surface) outside the base 20.

When an external force is applied to the solar cell panel 50, but the external force is smaller than the magnitude overcoming the friction, or when no external force is applied, the solar cell panel 50 is maintained at the tilt angle at that time due to the friction. Therefore, the magnitude of the external force applied to the solar cell panel 50 is varied to adjust the tilt angle of the solar cell panel 50 with respect to the base 20 and to maintain the solar cell panel 50 at the adjusted tilt angle.

When the tilt angle of the solar cell panel 50 with respect to the base 20 increases to some extent, a space into which fingers FI can be inserted is created around the base 20 and between the base 20 and the solar cell panel 50. As shown in FIG. 1, when the fingers FI are put in this space, the user can hold the photovoltaic power supply device A together with the mobile terminal 10 with little or no holding of the solar cell panel 50. The mobile terminal 10 can be used (operated) while the solar cell panel 50 generates electric power. The portion of the hand HA between the light source LS and the light receiving surface 56 is reduced or eliminated, and the irradiation of light to the light receiving surface 56 is less likely to be significantly blocked by the hand HA. The light receiving surface 56 is irradiated with a larger amount of light than in the photovoltaic power supply device A of a related art, in which irradiation of light is largely blocked by the hand HA.

In addition, in the use position, when the solar cell panel 50 is tilted around the shaft 82 to direct the light receiving surface 56 to the light source LS, more light is irradiated on the light receiving surface 56.

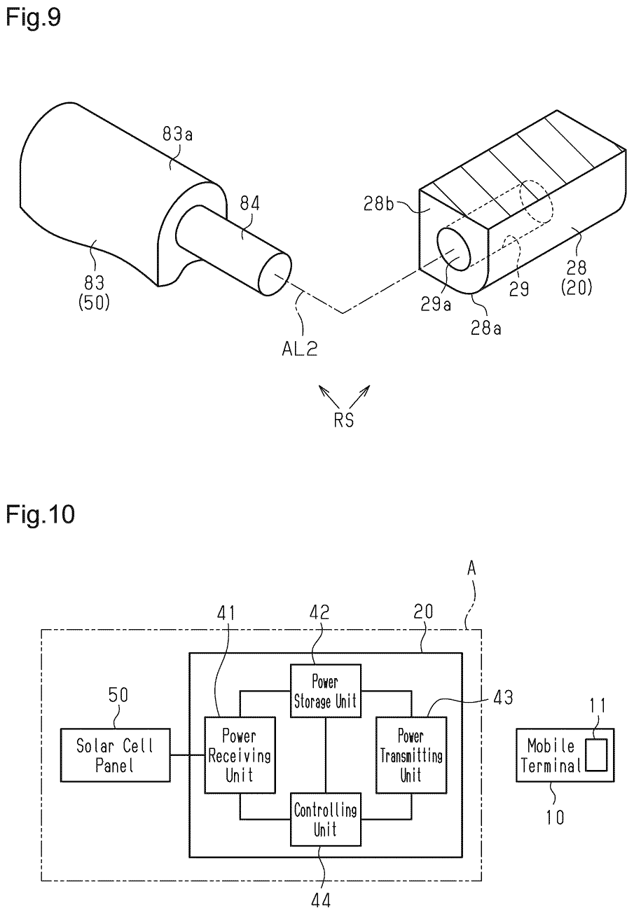

When the position of the solar cell panel 50 is changed, the shaft 82 is rotated around the first axis AL1 in the shaft receiving hole 27 as shown in FIG. 8. With the rotation of the shaft 82, the terminal portion 84 is rotated about the second axis AL2 in the connection hole 29, as shown in FIG. 9. The terminal portion 84 is rotated in a state in which the terminal portion 84 is in contact with the inner wall surface 29a of the connection hole 29, that is, in a state in which electrical connection is maintained, without hindering rotation of the shaft 82 with respect to the shaft receiving hole 27.

### Replacement of Solar Cell Panel 50

When the solar cell panel 50 malfunctions, the base 20 and the solar cell panel 50 are moved relative to each other in a direction along the first axis AL1 and the second axis AL2 in which the shaft 82 moves away from the shaft receiving hole 27 and the terminal portion 84 moves away from the connection hole 29. Then, as shown in FIG. 7, the shaft 82 is removed from the shaft receiving hole 27, and the solar cell panel 50 is no longer supported by the base 20 with the shaft receiving hole 27 and the shaft 82. Further, the terminal portion 84 is removed from the connection hole 29, and the connection of the connection portion to the connectable portion is discontinued. The electrical connection of the solar cell panel 50 to the base 20 is disconnected.

The solar cell panel 50 is removed from the base 20. Therefore, the solar cell panel 50 can be repaired in a detached state. The solar cell panel 50 can be repaired at a place away from the base 20.

The solar cell panel 50 after repair or another solar cell panel 50 that is not malfunctioning is referred to as a new solar cell panel 50.

The base 20 and the new solar cell panel 50 are moved relative to each other in opposite directions. The opposite directions are directions along the first axis AL1 and the second axis AL2 and include a direction in which the shaft 82 approaches the shaft receiving hole 27 and a direction in which the terminal portion 84 approach the connection hole 29. Then, the shaft 82 is inserted into the shaft receiving hole 27, and the new solar cell panel 50 is tiltably supported by the base 20 with the shaft 82. In addition, the terminal portion 84 is inserted into the connection hole 29, so that the new solar cell panel 50 is electrically connected to the base 20 via the terminal portion 84 and the connection hole 29. In this manner, the malfunctioning solar cell panel 50 is replaced with a functioning solar cell panel 50.

In addition, when the solar cell panel 50 is replaced with a solar cell panel having a different design, the shaft 82 is removed from the shaft receiving hole 27 by relative movement of the base 20 and the solar cell panel 50 in the same manner as described above. Further, the terminal portion 84 is removed from the connection hole 29. The solar cell panel 50 is thus removed from the base 20.

By the relative movement in the direction opposite to the above, the shaft 82 of the solar cell panel 50 having a different design is inserted into the shaft receiving hole 27, and the terminal portion 84 is inserted into the connection hole 29. Then, the solar cell panel 50 having a design different from that of the solar cell panel 50 before replacement is tiltably supported by the base 20 with the shaft 82, and is electrically connected to the base 20 via the terminal portion 84 and the connection hole 29. In this manner, the solar cell panel 50 is replaced with a solar cell panel 50 having a different design.

The first embodiment has the following advantages.

(1-1) As shown in FIG. 2, the solar cell panel 50 is supported by the base 20 with the shaft 82. The position of the solar cell panel 50 with respect to the base 20 can be changed by tilting the solar cell panel 50 about the shaft 82.

Therefore, by bringing the solar cell panel 50 into the use position, the user can hold the photovoltaic power supply device A together with the mobile terminal 10 without holding the solar cell panel 50 at all or without holding a large part of the solar cell panel 50. It is possible to prevent the irradiation of light to the light receiving surface 56 from being largely blocked by the hand HA, and to reduce the decrease in the power generation efficiency of the solar cell panel 50 due to the blocking.

In addition, in the use position, the solar cell panel 50 is tilted about the shaft 82 to direct the light receiving surface 56 toward the light source LS. This allows the light receiving surface 56 to be irradiated with more light and thus increases the power generation efficiency of the solar cell panel 50.

(1-2) In the use position, the solar cell panel 50 is tilted with respect to the base 20 as indicated by the long-dash double-short-dash lines in FIG. 2. Therefore, the size of the entire photovoltaic power supply device A in the thickness direction is increased.

In the first embodiment, when the solar cell panel 50 is brought into the retracted position, the entire solar cell panel 50 overlaps with the front surface 32 (base surface) as indicated by the solid lines in FIG. 2. Therefore, the overall size of the photovoltaic power supply device A in the thickness direction is reduced in the retracted position than in the use position.

(1-3) As shown in FIGS. 7 to 9, the solar cell panel 50 is provided with the shaft 82, and the base 20 is provided with the shaft receiving portion 26, which includes the shaft receiving hole 27. The shaft 82 is removably inserted into the shaft receiving hole 27 by relative movement of the base 20 and the solar cell panel 50. The base 20 is provided with a connectable portion, and the solar cell panel 50 is provided with a connection portion. The connection portion is connected to the connectable portion by the relative movement such that the connection portion and the connectable portion can be electrically disconnected.

Thus, if the solar cell panel 50 malfunctions, it can be removed from the base 20 and repaired. The repaired solar cell panel 50, or another solar cell panel 50 that is not malfunctioning, can be attached to the base 20. Further, the solar cell panel 50 can be replaced with a solar cell panel having a different design.

There is no need to replace or repurchase the base 20.

(1-4) As shown in FIGS. 7 to 9, the shaft 82 and the shaft receiving hole 27 extend along the first axis AL1. The connectable portion and the connection portion are formed by a combination of a connection hole 29 and a terminal portion 84 that extend along a second axis AL2 that is positioned on the same line as the first axis AL1. The terminal portion 84 is removably inserted into the connection hole 29 as the shaft 82 is inserted into the shaft receiving hole 27. When the terminal portion 84 inserted into the connection hole 29, the terminal portion 84 is supported by the inner wall surface 29a of the connection hole 29 so as to rotate about the second axis AL2 while being in contact with the inner wall surface 29a.

Therefore, despite its simple structure, the solar cell panel 50 can be selectively supported by the base 20 or not by moving the base 20 and the solar cell panel 50 relative to each other in directions along the first axis AL1 and the second axis AL2. In addition, the solar cell panel 50 can be selectively electrically connected to and disconnected from the base 20.

(1-5) By employing the configuration of item (1-4), the shaft 82 can be rotated in the shaft receiving hole 27 and the terminal portion 84 can be rotated in the connection hole 29, while maintaining the electrical connection. Further, it is possible to prevent the terminal portion 84 and the connection hole 29 from hindering rotation of the shaft 82 in the shaft receiving hole 27.

(1-6) As shown in FIG. 8, the friction generated between the shaft 82 and the inner wall surface 27a of the shaft receiving hole 27 when the shaft 82 is press-fitted into the shaft receiving hole 27 is set to such a magnitude that the angle of the solar cell panel 50 with respect to the base 20 can be adjusted.

Therefore, by varying the magnitude of the external force applied to the solar cell panel 50 in the thickness direction, the tilt angle of the solar cell panel 50 with respect to the base 20 can be adjusted, and the solar cell panel 50 can be maintained at the adjusted tilt angle.

(1-7) As shown in FIG. 10, the base 20 includes the power storage unit 42, which stores power generated by the solar cell panel 50, and the power transmitting unit 43, which transmits the power stored in the power storage unit 42 to the mobile terminal 10 by contactless power supply.

Therefore, even if the mobile terminal 10 is not connected to the base 20 of the photovoltaic power supply device A by a cable or the like, the transmitted power can be received and stored in the power storage unit 11. The power storage unit 11 can be easily charged by attaching the photovoltaic power supply device A to the mobile terminal 10 without concern for the connection state between the mobile terminal 10 and the photovoltaic power supply device A. In addition, since it is not necessary to carry a cable, convenience is improved.

(1-8) As shown in FIGS. 1 and 3, the photovoltaic power supply device A is attached to the mobile terminal 10 at a position separated from the lens 12. This allows the camera to capture images with the photovoltaic power supply device A attached to the mobile terminal 10.

### Second Embodiment

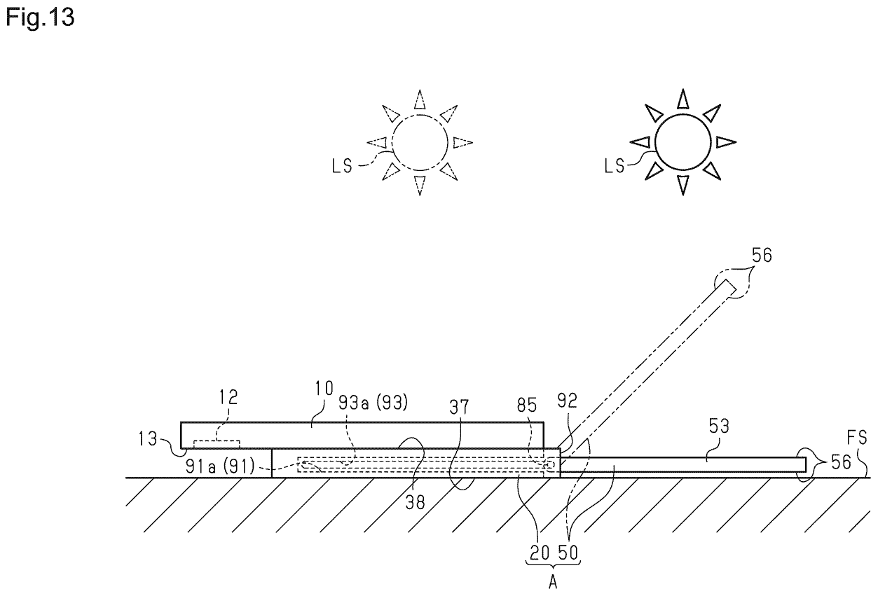

A photovoltaic power supply device A according to a second embodiment will now be described with reference to FIGS. 12 and 13.

Similarly to the first embodiment, a solar cell panel 50 according to the second embodiment has the shape of a rectangular plate.

A base 20 has the shape of a rectangular plate. Although the shape of the base 20 is slightly different from the shape described in the first embodiment, the base 20 includes a power receiving unit 41, a power storage unit 42, a power transmitting unit 43, and a controlling unit 44 shown in FIG. 10.

The dimension of the base 20 in the width direction is greater than the dimension of the solar cell panel 50 in the same direction. The dimension of the base 20 in the length direction is greater than the dimension of the solar cell panel 50 in the same direction.

As shown in FIGS. 12 and 13, an outer surface of the base 20, which is on one side in the thickness direction, will be referred to as a front surface 37, and the surface on the other side will be referred to as a back surface 38. In a state in which the photovoltaic power supply device A is attached to the mobile terminal 10, the front surface 37 is located on the opposite side to the back surface 13 of the mobile terminal 10, and the back surface 38 faces (is in contact with) the back surface 13.

The base 20 has a base surface that includes at least a part of the front surface 37 (the entire front surface 37 in the second embodiment). The base 20 includes an accommodating portion 91 for the solar cell panel 50. The accommodating portion 91 is a space that has a size capable of accommodating the entire solar cell panel 50, for example, a size slightly larger than the solar cell panel 50. The accommodating portion 91 extends in directions orthogonal to the thickness direction of the base 20, more specifically, in both the length direction and the width direction. The accommodating portion 91 opens in a part of the outer periphery of the base 20. In the second embodiment, the accommodating portion 91 opens in an end face 92 on one side in the length direction of the base 20. The end face 92 is one of the end faces on the opposite sides in the length direction. Specifically, the end face 92 is an end face on the side opposite to the lens 12 in a state in which the base 20 is attached to the mobile terminal 10.

Grooves 93 extending in the length direction are formed at two positions on the inner wall surface 91a of the accommodating portion 91 that face each other in the width direction.

The solar cell panel 50 includes shafts 85 that protrude from the side surfaces 52, 53 (only the side surface 53 on one side is shown in FIGS. 12 and 13). Each of the shafts 85 protrudes outward in the width direction from one end in the length direction. The shafts 85 are positioned on the same line.

The solar cell panel 50 is accommodated in the accommodating portion 91 in a manner that allows the shafts 85 to slide within the grooves 93. In other words, the solar cell panel 50 is arranged to be slidable relative to the base 20 in a direction orthogonal to the thickness direction.

A relay mechanism (not shown) that electrically connects the solar cell panel 50 and the base 20 to each other is provided therebetween. For example, a relay mechanism may be configured such that one of the shafts 85 has the same configuration as the connection portion (the terminal portion 84) in the first embodiment, and that the groove 93 with which that shaft 85 engages has the same configuration as the connectable portion (the connection hole 29) in the first embodiment.

In the second embodiment, a position in which the entire solar cell panel 50 is accommodated in the accommodating portion 91, that is, a position in which the entire solar cell panel 50 is accommodated inside the base 20 is referred to as a retracted position. In the retracted position, the shafts 85 are engaged with the grooves 93 at a position close to an end face on one of the opposite sides in the length direction of the base 20, specifically, at a position close to the end face opposite to the end face 92. A position in which the solar cell panel 50 does not overlap with the front surface 37 (base surface) outside the base 20 and can be tilted about the shafts 85 is referred to as the use position. The use position in the present embodiment is a position in which a large part of the solar cell panel 50 is out of the accommodating portion 91 in a state in which the shaft 85 are positioned at one end in the length direction of the corresponding groove 93, that is, in a state in which the shafts 85 remain in the base 20. In the use position, a portion of the solar cell panel 50 that is supported by the base 20 with the shafts 85 is located inside the base 20, and a portion of the solar cell panel 50 different from the supported portion is located outside the base 20. The use position includes not only a position in which the solar cell panel 50 is tilted with respect to the front surface 37 (base surface), but also a position in which the solar cell panel 50 is parallel with the front surface 37 (see solid lines in FIG. 13). In the use position, the solar cell panel 50 is tiltable with respect to the base 20 about the shafts 85.

In the use position, the friction generated between the shafts 85 and inner wall surfaces 93a of the grooves 93 is set to such a magnitude that the angle of the solar cell panel 50 with respect to the base 20 can be adjusted as in the first embodiment.

In addition, in the second embodiment, a solar cell panel having a configuration slightly different from that used in the first embodiment is used as the solar cell panel 50. As shown in FIG. 5, the thin-film solar cell 51 includes a power generation layer 66, a hole transport layer 67, an electron transport layer 68, positive electrodes 62, 71, negative electrode 63, and a sealing material 74 between the base members 61, 75.

The base member 61 and a member located between the base member 61 and the power generation layer 66 are made of a transparent or translucent material that is transmissive to light. This feature is the same as that of the first embodiment. In addition to this, in the second embodiment, the base member 75 and a member located between the base member 75 and the power generation layer 66 are made of a transparent or translucent material that is transmissive to light. The corresponding members include the hole transport layer 67, the positive electrode 71, and the sealing material 74.

Both an outer surface on one side of the base member 61 in the thickness direction and an outer surface on one side of the base member 75 in the thickness direction each form the light receiving surface 56. The thin-film solar cell 51 thus has the light receiving surfaces 56 on the opposite surfaces in the thickness direction. Regardless of which light receiving surface 56 is irradiated with light, the light reaches the power generation layer 66.

In the second embodiment, opposite side portions in the thickness direction of the accommodating portion 91 in the base 20 shown in FIGS. 12 and 13 are made of an opaque material having a low light transmissivity.

In the second embodiment, the same components as those in the first embodiment are given the same reference numerals, and detailed explanations are omitted.

Next, operation of the photovoltaic power supply device A according to the second embodiment configured as described above will be described focusing on differences from the first embodiment.

### Power Supply to Mobile Terminal 10

The photovoltaic power supply device A is attached to the back surface 13 of the mobile terminal 10, which is compatible with contactless power supply, on the back surface 38 of the base 20. Specifically, the base 20 is attracted to a predetermined position on the mobile terminal 10 by the magnetic force of the magnet while the back surface 38 is placed against the back surface 13 with the position of the back surface 38 determined. This attachment is preferably performed in a state in which the lens 12 is exposed so that the camera can capture images even in a state in which the photovoltaic power supply device A is attached to the mobile terminal 10. Through this attachment, the mobile terminal 10 is electrically connected to the photovoltaic power supply device A.

As shown in FIG. 10, the power stored in the power storage unit 42 of the base 20 is transmitted to the mobile terminal 10 by contactless power supply, and is stored in the power storage unit 11, as in the first embodiment. Power can be supplied from the photovoltaic power supply device A to the mobile terminal 10 regardless of the position of the solar cell panel 50.

The mobile terminal 10 operates using the power stored in the power storage unit 11, enabling its calling and communication functions. The mobile terminal 10 can operate with or without the photovoltaic power supply device A attached to the mobile terminal 10. Furthermore, when the solar power supply device A is attached, the mobile terminal 10 can function regardless of the orientation of the solar cell panel 50.

### Power Generation and Power Storage by Photovoltaic Power Supply Device A

In the retracted position, the entire solar cell panel 50 is accommodated in the accommodating portion 91. The light receiving surfaces 56 are both located in the accommodating portion 91. The light from the light source LS does not reach or barely reaches the accommodating portion 91. Therefore, the solar cell panel 50 does not generate power not only when the photovoltaic power supply device A is not held, but also when the photovoltaic power supply device A is held together with the mobile terminal 10.

When the photovoltaic power supply device A generates power, an external force is applied to a portion of the solar cell panel 50 exposed from the accommodating portion 91 in a direction in which the solar cell panel 50 is removed from the accommodating portion 91 of the base 20. As shown in FIGS. 12 and 13, this external force causes the shafts 85 of the solar cell panel 50 to slide along the grooves 93. The direction of the sliding movement is a direction away from the lens 12 of the mobile terminal 10 along the length of the base 20.

When the shafts 85 slide to one end of the grooves 93, the solar cell panel 50 is brought into the use position. The lens 12 of the mobile terminal 10 is not covered by the solar cell panel 50 in the use position. Even in a state in which the solar cell panel 50 is in the use position, the camera can capture images.

In the use position, both of the light receiving surfaces 56 are exposed from the accommodating portion 91.

In the use position, a portion of the solar cell panel 50 that is supported by the base 20 with the shafts 85 is located inside the base 20, and a portion of the solar cell panel 50 different from the supported portion is located outside the base 20. The solar cell panel 50 is tilted with respect to the base 20 about the shaft 85 so that one of the light receiving surfaces 56 faces the light source LS. The light from the light source LS is irradiated on the light receiving surface 56 facing the light source LS.

When the light of the light source LS shown in FIG. 5 is irradiated on the light receiving surface 56 of the base member 61, the light is transmitted through the base member 61 and transmitted through a member (including the electron transport layer 68) disposed between the base member 61 and the power generation layer 66, to reach the power generation layer 66.

When the light of the light source LS (not shown) is irradiated on the light receiving surface 56 of the base member 75, the light is transmitted through the base member 75, is transmitted through a member (including the hole transport layer 67) disposed between the base member 75 and the power generation layer 66, and reaches the power generation layer 66.

When the light reaches the power generation layer 66 as described above, holes and electrons are generated by photoexcitation in the power generation layer 66. The holes are transported to the positive electrode 71, 62 by the hole transport layer 67, and the electrons are transported to the negative electrode 63 by the electron transport layer 68. Then, a current is extracted from the wiring member 64, connected to the positive electrode 62, and the wiring member 65, connected to the negative electrode 63.

Therefore, even in a case in which the light receiving surface 56 of any of the base members 61, 75 is directed toward the light source LS, power having a magnitude corresponding to the amount of light with which the light receiving surface 56 is irradiated is generated in the power generation layer 66.

As long as the solar cell panel 50 is in the use position, power generation is possible even in a state in which the photovoltaic power supply device A is attached to the mobile terminal 10 or in a case in which the photovoltaic power supply device A is used alone without being attached to the mobile terminal 10.

Power generation is also possible by directing the light receiving surface 56 of the solar cell panel 50 in the use position toward the light source LS. At this time, as shown in FIG. 12, the solar cell panel 50 may be tilted in a state in which the base 20 is held together with the mobile terminal 10. Since the lens 12 is not blocked by the solar cell panel 50, the camera can capture images.

Further, as shown in FIG. 13, the photovoltaic power supply device A attached to the mobile terminal 10 may be placed on a flat surface FS such as a desk without being held. In this case, the front surface 37 (base surface) of the base 20 is placed against the flat surface FS. The mobile terminal 10 is placed on the base 20. As indicated by solid lines in FIG. 13, the solar cell panel 50 is removed from the accommodating portion 91 to be in the use position. The solar cell panel 50 is tilted about the shaft 85 in correspondence with the position of the light source LS such that the light receiving surface 56 faces the light source LS, as indicated by the long-dash double-short-dash lines in FIG. 13.

In this manner, even in a state in which the photovoltaic power supply device A is placed on the flat surface FS, it is possible to irradiate the light receiving surface 56 with a large amount of light by adjusting the orientation of the light receiving surface 56 in correspondence with the position of the light source LS. At this time, the mobile terminal 10 may be used for a call, communication, or the like.

Although not illustrated, power generation is also possible when the photovoltaic power supply device A is used alone without being attached to the mobile terminal 10.

As described above, power generated by the solar cell panel 50 is supplied to the power receiving unit 41 shown in FIG. 10 via the wiring members 64, 65, the shafts 85, and the grooves 93. The power is then stored in the power storage unit 42 by the controlling unit 44 controlling the power receiving unit 41.

### Reduction of Decrease in Power Generation Efficiency of Solar Cell Panel 50

When the mobile terminal 10 to which the photovoltaic power supply device A is attached is used, if the solar cell panel 50 is in the retracted position, the light of the light source LS does not reach the solar cell panel 50, and power is not generated as described above.

When the solar cell panel 50 is in the use position as shown in FIG. 12, the solar cell panel 50 is tiltable about the shafts 85 located at one end of the grooves 93. In addition, as in the first embodiment, friction large enough to allow the angle of the solar cell panel 50 to be adjusted is generated between the shafts 85 and the inner wall surfaces 93a of the grooves 93.

Therefore, when the mobile terminal 10 is used, an external force by the fingers FI is applied to the solar cell panel 50 in the use position in the thickness direction. When an external force large enough to overcome the friction is applied to the solar cell panel 50, the solar cell panel 50 is tilted about the shaft 85. This tilting action changes the tilt angle of the solar cell panel 50 with respect to the base 20. The tilting is performed in a state in which the shafts 85 are in contact with the inner wall surfaces 93a of the grooves 93, that is, in a state in which the shafts 85 are electrically connected to the power receiving unit 41 (see FIG. 10) in the base 20.

When an external force smaller than the above-mentioned magnitude is applied to the solar cell panel 50, or when no external force is applied, the solar cell panel 50 is maintained at the tilt angle at that time by friction. Therefore, the magnitude of the external force applied to the solar cell panel 50 is varied to adjust the tilt angle of the solar cell panel 50 with respect to the base 20 and to maintain the solar cell panel 50 at the adjusted tilt angle.

In the use position, the solar cell panel 50 is located outside the base 20 and does not overlap with the front surface 37 (base surface). If the tilt angle of the solar cell panel 50 with respect to the base 20 is not significantly small, a space into which the fingers FI can be inserted is formed around the base 20 and between the solar cell panel 50 and the base 20. When fingers are put in this space, it is possible to hold the photovoltaic power supply device A together with the mobile terminal 10 without holding the solar cell panel 50 as shown in FIG. 12. The portion of the hand HA between the light source LS and the light receiving surface 56 is reduced or eliminated, and the irradiation of light to the light receiving surface 56 is less likely to be significantly blocked by the hand HA. The light receiving surface 56 is irradiated with a larger amount of light than in the photovoltaic power supply device A of a related art, in which irradiation of light is largely blocked by the hand HA.

Further, in the use position, the light receiving surface 56 can be directed toward the light source LS by tilting the solar cell panel 50 about the shafts 85. Directing the light receiving surface 56 toward the light source LS allows the light receiving surface 56 to be irradiated with a greater amount of light.

The photovoltaic power supply device A according to the second embodiment has the following advantages. The second embodiment has the following advantages in addition to the advantages of the items (1-7) and (1-8).

(2-1) The solar cell panel 50 is supported by the base 20 with the shafts 85. The position of the solar cell panel 50 with respect to the base 20 can be changed by tilting the solar cell panel 50 about the shaft 85.

Therefore, bringing the solar cell panel 50 into the use position prevents the irradiation of light to the light receiving surface 56 from being blocked by the hand HA, and directing the light receiving surface 56 toward the light source LS allows the light receiving surface 56 to be irradiated with a greater amount of light. Accordingly, similarly to the advantage of item (1-1), it is possible to increase the power generation efficiency of the solar cell panel 50 while using the mobile terminal 10.

(2-2) In the use position, a portion of the solar cell panel 50 that is supported by the base 20 with the shafts 85 is located inside the base 20, and a portion of the solar cell panel 50 different from the supported portion is located outside the base 20. Therefore, in the use position, the size of the entire photovoltaic power supply device A is increased in at least one of the thickness direction of the base 20 and the direction in which the solar cell panel 50 is inserted into and removed from the base 20.

In the second embodiment, the entire solar cell panel 50 is accommodated in the base 20 in the retracted position. Therefore, in the retracted position, the size of the entire photovoltaic power supply device A is reduced in both the direction in which the solar cell panel 50 is inserted into and removed from the base 20 and the thickness direction of the base 20, as compared with the use position, in which the solar cell panel 50 is located outside the base 20.

(2-3) The friction generated between the shafts 85 and the inner wall surfaces 93a of the grooves 93 is set to be large enough to allow for adjustment of the angle of the solar cell panel 50 with respect to the base 20. Therefore, similarly to advantage of item (1-6), when the solar cell panel 50 is in the use position, the tilt angle of the solar cell panel 50 with respect to the base 20 can be adjusted by varying the magnitude of the external force applied to the solar cell panel 50, and the solar cell panel 50 can be maintained at the adjusted tilt angle.

(2-4) In the thin-film solar cell 51 shown in FIG. 5, the base member 61 and a member located between the base member 61 and the power generation layer 66 are made of a material that is transmissive to light. In addition, the base member 75 and the member located between the base member 75 and the power generation layer 66 are made of a material that is transmissive to light. Therefore, in a case in which the light receiving surface 56 of any of the base members 61, 75 is irradiated with light, that is, in a case in which the light receiving surface 56 is directed to the light source LS, the power generation layer 66 is capable of generating power.

The above-described embodiments may be modified as follows. The above-described embodiments and the following modifications can be combined as long as the combined modifications remain technically consistent with each other.

### Modifications to First and Second Embodiments

In the first and second embodiments, the positive electrode 62 is stacked on the single base member 61 together with the negative electrode 63 as shown in FIG. 5. However, only the negative electrode 63 may be stacked on the base member 61, and the positive electrode 62 may be stacked on the base member 75. That is, the negative electrode 63 and the positive electrode 62 may be stacked on different base members 61, 75.

In this case, the negative electrode 63 is disposed between the base member 61 and the electron transport layer 68. The positive electrode 62 is disposed between the base member 75 and the hole transport layer 67. The positive electrode 71 is omitted.

The base surface of the base 20 may be formed by at least a part of the front surface 32, 37. Thus, the entire front surface 32, 37 may be a base surface, or only a part of the front surface 32, 37 may be a base surface.

In a case in which the light receiving surface 56 is provided on the outer surface of the solar cell panel 50, which is on at least one side in the thickness direction, the light receiving surface 56 may be provided on part of or the entirety of the outer surface.

As a structure for detachably attaching the photovoltaic power supply device A to the mobile terminal 10, an attachment structure different from that used in the first and second embodiments (attraction by a magnet) may be employed.

In FIG. 10, the power transmitting unit 43 of the photovoltaic power supply device A may be connected to the mobile terminal 10 by a cable or the like. Power generated by the solar cell panel 50 may be stored in the power storage unit 42 in the base 20, and the power may be supplied to the mobile terminal 10 by the power transmitting unit 43 via a cable or the like.

### Modifications to First Embodiment

During power generation by the solar cell panel 50, there may be situations where no issues arise even if image capturing by the camera is obstructed by the solar cell panel 50 In this case, the base 20 may be attached to the mobile terminal 10 in a state in which the base 20 overlaps with the lens 12 in FIG. 2 and the like.

In FIGS. 3 and 4, the shaft 82 may be inserted into the shaft receiving hole 27 in a non-removable manner. Further, the terminal portion 84 may be inserted into the connection hole 29 in a non-removable manner. However, in this case, it is difficult to remove the solar cell panel 50 from the base 20.

Unlike the first embodiment, the connectable portion in the base 20 may include the terminal portion 84, and the connection portion in the solar cell panel 50 may include the connection hole 29. In this case, the terminal portion 84 is inserted into the connection hole 29 as the shaft 82 is inserted into the shaft receiving hole 27.

Unlike the first embodiment, the shaft 82 may be provided on the base 20, and the shaft receiving portion 26 having the shaft receiving hole 27 may be provided on the solar cell panel 50. In this case, similarly to the first embodiment, the connectable portion in the base 20 may include the connection hole 29, and the connection portion in the solar cell panel 50 may include the terminal portion 84. In addition, unlike the first embodiment, the connectable portion in the base 20 may include the terminal portion 84, and the connection portion in the solar cell panel 50 may include the connection hole 29. In either case, the terminal portion 84 is inserted into the connection hole 29 as the shaft 82 is inserted into the shaft receiving hole 27.

The shaft receiving hole 27 in FIG. 7 and other drawings may either extend through the shaft receiving portion 26 or not. Similarly, the connection hole 29 may extend through the protrusion 28 or not.

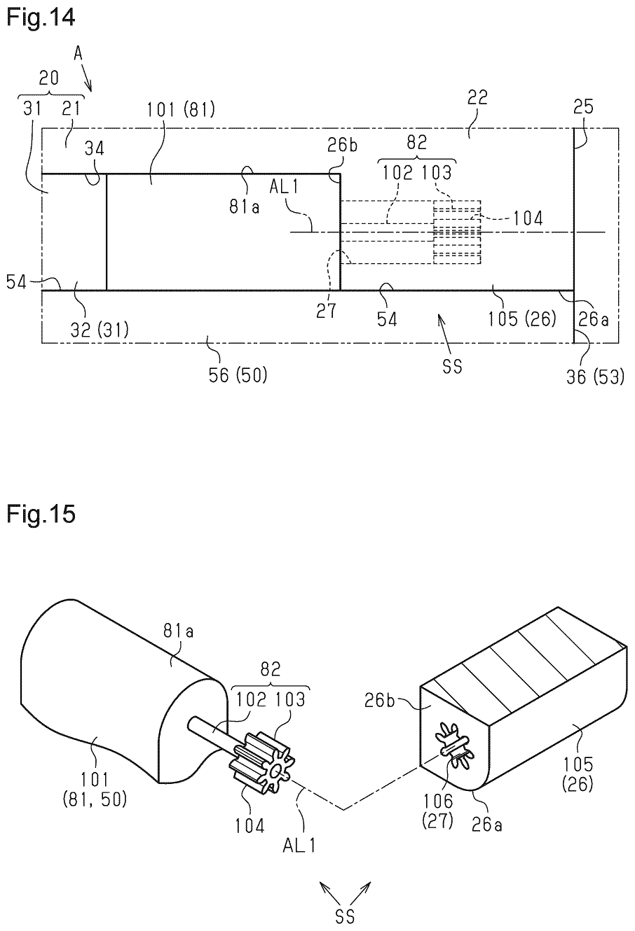

FIGS. 14 and 15 illustrate a modification of the support structure SS, in which part or the entirety the protrusion 81 may be formed by a motor 101 having a rotary shaft 102 extending in the direction along the first axis AL1. In this case, the motor 101 is fixed to the solar cell panel 50. The rotary shaft 102 is removably inserted into the shaft receiving hole 27. In a state in which the rotary shaft 102 is inserted into the shaft receiving hole 27, the rotary shaft 102 is coupled to the shaft receiving hole 27 so as to be integrally rotatable with the shaft receiving hole 27.

For example, an external gear 103 having multiple external teeth 104 extending along the first axis AL1 is attached to the rotary shaft 102 so as to be integrally rotatable with the rotary shaft 102. The rotary shaft 102 and the external gear 103 form the shaft 82. The shaft receiving portion 26 is formed by an internal gear 105 having multiple internal teeth 106 extending along the first axis AL1 in the shaft receiving hole 27.

The external teeth 104 of the external gear 103 are meshed with the internal teeth 106 of the internal gear 105, so that the shaft 82 and the shaft receiving hole 27 are coupled to each other to rotate integrally. The internal teeth 106 are not shown in FIG. 14

Since the external teeth 104 and the internal teeth 106 extend along the first axis AL1, the external gear 103 and the internal gear 105 can be coupled to each other or disconnected from each other by moving the gears 103 and 105 relative to each other in a direction along the first axis AL1. The shaft 82 is inserted into the shaft receiving hole 27 by moving the external gear 103 and the internal gear 105 toward each other along the first axis AL1. When the external teeth 104 and the internal teeth 106 are meshed with each other by the insertion, the shaft 82 is coupled to the shaft receiving hole 27 so as to be integrally rotatable. From this coupled state, the external gear 103 and the internal gear 105 are moved away from each other along the first axis AL1, so that the shaft 82 is removed from the shaft receiving hole 27. When the external gear 103 and the internal gear 105 are no loner meshed each other by the removal, the shaft 82 is disconnected from the shaft receiving hole 27.

According to this modification, when the rotary shaft 102 of the motor 101 rotates, the rotation is transmitted to the shaft receiving hole 27 via the external teeth 104 of the external gear 103 and the internal teeth 106 of the internal gear 105. By the transmission of the rotation, the solar cell panel 50 is tilted about the shaft 82 with respect to the base 20. This allows the tilt angle of the solar cell panel 50 with respect to the base 20 to be adjusted by tilting the solar cell panel 50 so that the light receiving surface 56 faces the light source LS without applying an external force to the solar cell panel 50 with the hand HA or the like.

In addition, when the shaft 82 is removed from the shaft receiving hole 27, the solar cell panel 50 is no longer supported by the base 20 with the shaft 82 and the shaft receiving hole 27. When the shaft 82 is inserted into the shaft receiving hole 27, the solar cell panel 50 is supported by the base 20 with the shaft 82 and the shaft receiving hole 27. Therefore, also in this modification, it is possible to repair and replace the malfunctioning solar cell panel 50, and to change the solar cell panel 50 for design change.

In contrast to the modification of FIGS. 14 and 15, the base 20 may be provided with the motor 101 having the rotary shaft 102, to which the external gear 103 is attached to be integrally rotatable. The internal gear 105 including the internal teeth 106 in the shaft receiving hole 27 may be provided in the solar cell panel 50.

In order to couple the rotary shaft 102 of the motor 101 in the modification of FIGS. 14 and 15 to the shaft receiving hole 27 such that the rotary shaft 102 and the shaft receiving hole 27 are integrally rotatable without using the external gear 103, the rotary shaft 102 and the shaft receiving hole 27 may be coupled to each other by spline-engagement. In this case, external teeth are formed on the outer circumferential surface of the rotary shaft 102, and internal teeth are formed on the inner wall surface of the shaft receiving hole 27. The shaft 82 includes the rotary shaft 102 having external teeth on its outer circumferential surface.

In FIG. 10, power may be supplied from the solar cell panel 50 to the power receiving unit 41 by contactless power supply.

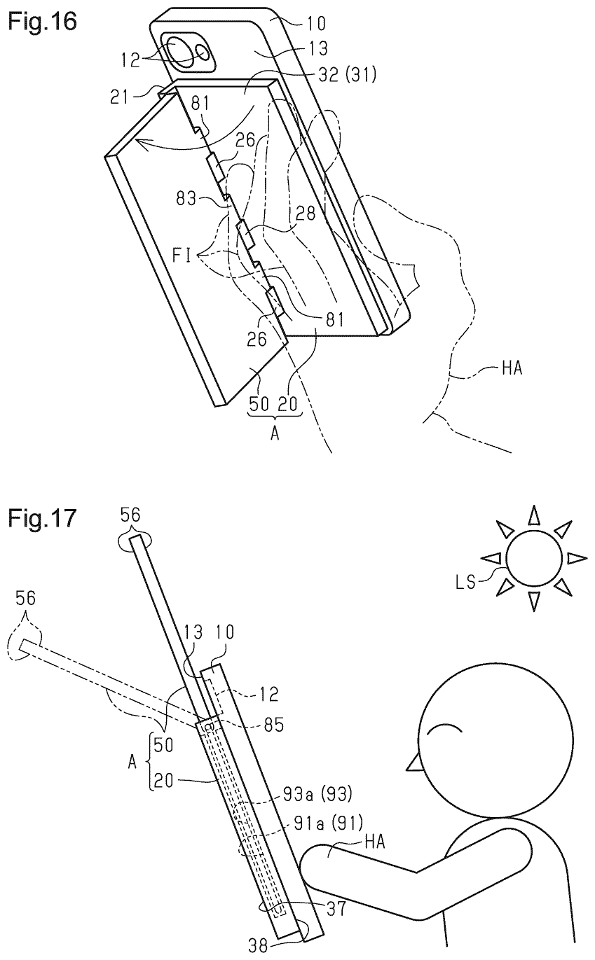

The tilting direction of the solar cell panel 50 with respect to the base 20 may be changed to a direction different from that in the first embodiment. FIG. 16 shows a modification. In this modification, the first functional portion 21 and the second functional portion 31 are adjacent to each other in the width direction (lateral direction in FIG. 16) instead of the length direction of the base 20.

A protrusion 81 having a shaft and a shaft receiving portion 26 having a shaft receiving hole are arranged in the length direction. The axis of the shaft and the shaft receiving hole extends in the length direction. The direction in which the axis extends is a direction orthogonal to the direction in which the first axis AL1 and the second axis AL2 extend in the first embodiment. The solar cell panel 50 is supported by the shaft inserted into the shaft receiving hole so as to be tiltable in a direction indicated by the arrow in FIG. 16.

In this case as well, the position of the solar cell panel 50 with respect to the base 20 can be changed by tilting the solar cell panel 50. The entirety of the solar cell panel 50 overlaps with the front surface 32 (base surface) from the outside of the base 20, and thus the solar cell panel 50 is in a retracted position (not shown). In addition, when the solar cell panel 50 is brought into the use position, the solar cell panel 50 does not overlap with the front surface 32 (base surface) outside the base 20, and is tiltable the axis.

Therefore, by bringing the solar cell panel 50 into the use position, the user can hold the photovoltaic power supply device A together with the mobile terminal 10 without holding the solar cell panel 50 as shown in FIG. 16. It is possible to prevent the irradiation of light to the light receiving surface from being largely blocked by the hand HA, and thus reduce the decrease in the power generation efficiency of the solar cell panel 50.

In addition, in the use position, the solar cell panel 50 is tilted about the shaft to direct the light receiving surface toward the light source. This allows the light receiving surface to be irradiated with more light and thus increases the power generation efficiency of the solar cell panel 50.

As shown in FIG. 16, a protrusion 83 having a terminal portion and a protrusion 28 having a connection hole may be arranged in the length direction. In this case as well, the solar cell panel 50 can be electrically connected to the base 20 by inserting the terminal portion into the connection hole in a contact state.

In FIGS. 3 and 7, multiple combinations of the protrusion 81 having the shaft 82 and the shaft receiving portion 26 having the shaft receiving hole 27 may be provided.

In FIG. 5, the thin-film solar cell 51 according to the second embodiment, in which each base member 61, 75 has the light receiving surface 56, may be used as the thin-film solar cell 51 of the solar cell panel 50 according to the first embodiment.

The relay structure RS may be implemented by a structure different from that of the first embodiment, in which the terminal portion 84 is inserted into the connection hole 29 in a contact state. In this case, the relay structure RS may be provided at a position different from the position on the second axis AL2.

### Modifications to Second Embodiment

During power generation by the solar cell panel 50, there may be situations where no issues arise even if image capturing by the camera is obstructed by the solar cell panel 50 Therefore, when the solar cell panel 50 is switched from the retracted position to the use position, the solar cell panel 50 in the accommodating portion 91 may be slid in a direction approaching the lens 12 along the length of the base 20 as indicated by the solid lines in FIG. 17.

In this case, as shown in FIG. 17, the solar cell panel 50 is tilted about the shafts 85 in a state in which the base 20 is held together with the mobile terminal 10. This tilting action directs the light receiving surface 56 toward the light source LS, as indicated by the solid lines in FIG. 17, so as to increase the power generation efficiency of the solar cell panel 50. In addition, the solar cell panel 50 may be tilted in correspondence with the position of the light source LS so that the light receiving surface 56 is directed toward the light source LS. The solar cell panel 50 indicated by the long-dash double-short-dash lines in FIG. 17 is an example of the tilted solar cell panel 50.

As in the modification of the first embodiment shown in FIG. 16, the tilting direction of the solar cell panel 50 with respect to the base 20 may be changed to a direction different from that in the second embodiment. For example, the solar cell panel 50 in the retracted position may be moved in the width direction of the base 20 to be in the use position. In the use position, a portion supported that is by the base 20 with the shaft 85 remains in the accommodating portion 91, and a portion different from the supported portion is removed to the outside in the width direction of the base 20. The light receiving surface 56 is directed to the light source LS by tilting the solar cell panel 50 about the shaft 85 extending in the length direction.

In FIGS. 12, 13, and 17, in the base 20, at least one of the side portions on the opposite sides of the accommodating portion 91 in the thickness direction may be made of a transparent or translucent material that is transmissive to light. With this modification, it is possible to irradiate the light receiving surface 56 with light even when the solar cell panel 50 is in the retracted position. The solar cell panel 50 can generate power even in the retracted position.

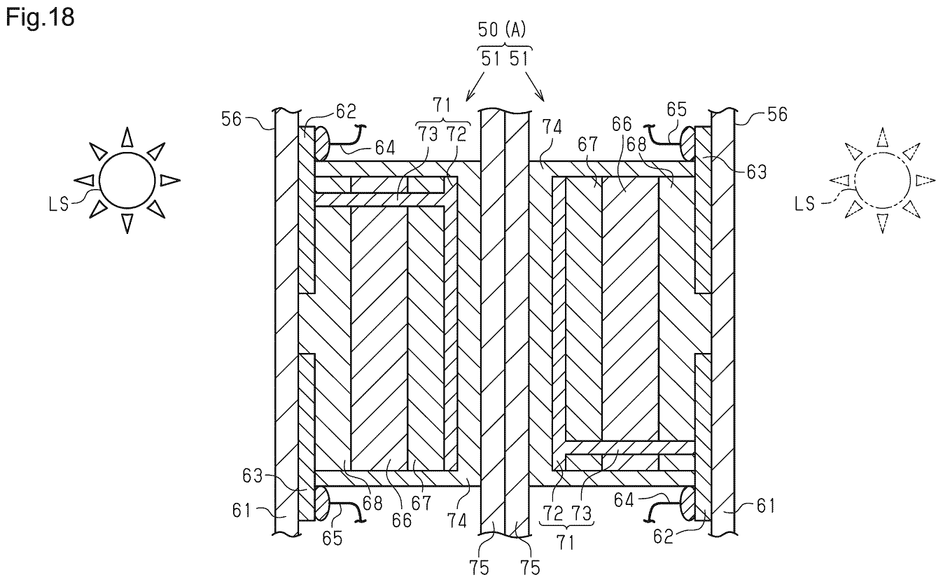

A structure different from that of the second embodiment may be employed as a structure in which surfaces on the opposite sides in the thickness direction of the solar cell panel 50 include the light receiving surfaces 56. FIG. 18 shows such a modification. In the first embodiment, the single thin-film solar cell 51 is used as the solar cell panel 50 as shown in FIG. 5. The light receiving surface 56 of the thin-film solar cell 51 according to the first embodiment is an outer surface that is on one side in the thickness direction of the thin-film solar cell 51.

In contrast, the solar cell panel 50 of the modification shown in FIG. 18 includes two thin-film solar cells 51 having the same structure as the thin-film solar cell in the first embodiment. Specifically, the two thin-film solar cells 51 of the solar cell panel 50 of the modification each include, as the light receiving surface 56, an outer surface that is on one side in the thickness direction of the thin-film solar cell 51.

The two thin-film solar cells 51 of the modification are disposed back to back such that the light receiving surfaces 56 form surfaces on the opposite sides in the thickness direction of the solar cell panel 50. That is, the two thin-film solar cells 51 are arranged such that the base members 75 are adjacent to each other.

With this modification, even if the light from the light source LS is radiated on the solar cell panel 50 from any side in the thickness direction, the thin-film solar cell 51 on the irradiated side generates power. Therefore, even when any of the light receiving surfaces 56 is directed toward the light source LS, it is possible to generate power.

The configuration of this modification may be employed in the solar cell panel 50 according to the first embodiment.

In the second embodiment, the shaft 85 may be removably engaged with the groove 93 or may be unremovably engaged with the groove 93. In the former case, the solar cell panel 50 can be attached to and detached from the base 20. The same advantage as the advantage of item (1-3) of the first embodiment is achieved. Specifically, it is possible to repair and replace the solar cell panel 50 when the solar cell panel 50 malfunctions, and to replace the solar cell panel 50 with a solar cell panel having a different design.

The thin-film solar cell 51 according to the first embodiment, which has the light receiving surface 56 on only one of the base members 61 and 75, may be used as the solar cell panel 50 according to the second embodiment.

### Other Modifications

The electronic device may be changed to an electronic device different from the mobile terminal 10 as long as the electronic device is small enough to be held in a state in which the photovoltaic power supply device A is attached and operates by being supplied with power generated by the photovoltaic power supply device A.

For example, the electronic device may be a wearable device. A wearable device is worn on a living body (e.g., a human body), and is typically a wearable terminal (e.g., a smart watch or smart glasses).

The power supplied from the power transmitting unit 43 of the photovoltaic power supply device A shown in FIG. 10 to the electronic device may be used for a purpose different from power storage by the power storage unit 11 of the electronic device. The power may be used, for example, to cause the electronic device to perform functions of the main body. Further, in a case in which the electronic device includes an electric product, such as a cooling fan, which exhibits a function not directly related to the original function of the electronic device, the power may be used for the operation of the electric product.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A photovoltaic power supply device, comprising:
a base removably attached to an electronic device and including a base surface on an outer surface on one side in a thickness direction of the base; and
a solar cell panel electrically connected to the base and including a light receiving surface on an outer surface on at least one side in a thickness direction of the solar cell panel, wherein
the photovoltaic power supply device is configured such that power generated by the solar cell panel is supplied to the electronic device via the base,
the solar cell panel is supported by the base with a shaft,
a position of the solar cell panel with respect to the base is variable, and
the position includes:
a retracted position in which the entirety of the solar cell panel overlaps with the base surface from the outside of the base or is accommodated inside the base; and
a use position in which the solar cell panel does not overlap with the base surface outside the base and is tiltable about the shaft.

2. The photovoltaic power supply device according to claim 1, wherein
one of the base and the solar cell panel is provided with the shaft, and the other is provided with a shaft receiving portion including a shaft receiving hole,
the shaft is removably inserted into the shaft receiving hole by relative movement of the base and the solar cell panel,
the base is provided with a connectable portion,
the solar cell panel is provided with a connection portion, and
the connection portion is connected to the connectable portion by relative movement of the base and the solar cell panel such that the connection portion and the connectable portion can be electrically disconnected.

3. The photovoltaic power supply device according to claim 2, wherein
the shaft and the shaft receiving hole extend along a first axis,
the connectable portion and the connection portion include a combination of a connection hole and a terminal portion that extend along a second axis that is positioned on a same line as the first axis,
the terminal portion is removably inserted into the connection hole as the shaft is inserted into the shaft receiving hole, and
in a state in which the terminal portion is inserted into the connection hole, the terminal portion is supported by an inner wall surface of the connection hole so as to rotate about the second axis while being in contact with the inner wall surface.

4. The photovoltaic power supply device according to claim 2, wherein
the shaft is fixed to one of the base and the solar cell panel,
the shaft is press-fitted into the shaft receiving hole, and
friction generated between the shaft and an inner wall surface of the shaft receiving hole when the shaft is press-fitted into the shaft receiving hole is set to such a magnitude that an angle of the solar cell panel with respect to the base is adjustable.

5. The photovoltaic power supply device according to claim 2, wherein
a motor is fixed to the one of the base and the solar cell panel,
at least a part of the shaft is formed by a rotary shaft of the motor,
the rotary shaft is removably inserted into the shaft receiving hole, and
in a state in which the rotary shaft is inserted into the shaft receiving hole, the rotary shaft is coupled to the shaft receiving hole so as to be integrally rotatable with the shaft receiving hole.

6. The photovoltaic power supply device according to claim 1, wherein
the solar cell panel is disposed so as to be movable with respect to the base in a direction orthogonal to the thickness direction,
in the retracted position, the entire solar cell panel is accommodated in the base, and
in the use position, a portion of the solar cell panel that is supported by the base with the shaft is located inside the base, and a portion of the solar cell panel different from the supported portion is located outside the base.

7. The photovoltaic power supply device according to claim 1, wherein
the solar cell panel includes a thin-film solar cell in which portions on both sides in a thickness direction of the thin-film solar cell are formed by two base members,
the thin-film solar cell includes, between the two base members:
a power generation layer that performs photoelectric conversion;
a hole transport layer and an electron transport layer that are disposed on opposite sides of the power generation layer in a thickness direction of the power generation layer;
a positive electrode that is connected to the hole transport layer; and
a negative electrode that is connected to the electron transport layer,
surfaces on opposite sides in the thickness direction of the thin-film solar cell form the light receiving surfaces, and
each base member and a member located between each base member and the power generation layer are made of a material that is transmissive to light.

8. The photovoltaic power supply device according to claim 1, wherein
the solar cell panel includes two thin-film solar cells each having a surface on one outer side in a thickness direction of the thin-film solar cell as the light receiving surface, and
the two thin-film solar cells are disposed back to back such that the light receiving surfaces form surfaces on opposite sides in the thickness direction of the solar cell panel.

9. The photovoltaic power supply device according to claim 1, wherein the base includes:
a power storage unit that stores power generated by the solar cell panel; and
a power transmitting unit that transmits the power stored in the power storage unit to the electronic device through contactless power supply.
